(19) United States
(12) Patent Application Publication
(10) Pub. No.: US 2024/0162497 A1
(43) Pub. Date: May 16, 2024

(54) SOLID-STATE BATTERY

(71) Applicant: TOYOTA JIDOSHA KABUSHIKI KAISHA, Toyota-shi (JP)

(72) Inventor: Yushi SUZUKI, Mishima-shi (JP)

(73) Assignee: TOYOTA JIDOSHA KABUSHIKI KAISHA, Toyota-shi (JP)

(21) Appl. No.: 18/472,938

(22) Filed: Sep. 22, 2023

(30) Foreign Application Priority Data
Nov. 10, 2022 (JP) 2022-180366

(51) Int. Cl. H01M 10/058; H01M 4/66

(52) U.S. Cl. CPC H01M 10/058; H01M 4/661

(57) ABSTRACT

A solid-state battery according to this disclosure is a solid-state battery including a first current collector layer, a first active material layer, a separator layer, a second active material layer, a second current collector layer, and an insulating layer that are laminated in this order. The first current collector layer is wound on a laminated body including the first active material layer, the separator layer, the second active material layer, the second current collector layer, and the insulating layer to surround the laminated body. The first current collector layer forms an outer packaging body such that overlapped parts of the first current collector are joined to each other at a position overlapping with a surface of the laminated body in its lamination direction.

### CROSS-REFERENCE TO RELATED APPLICATION

This application claims priority to Japanese Patent Application No. 2022-180366 filed on Nov. 10, 2022, incorporated herein by reference in its entirety.

### BACKGROUND

### 1. Technical Field

This disclosure relates to a solid-state battery.

### 2. Description of Related Art

Japanese Unexamined Patent Application Publication No. 2019-21636 (JP 2019-21636 A) describes an electrical storage device sheet including a positive-side sheet body, a negative-side sheet body, and a separator placed between the positive-side sheet body and the negative-side sheet body. The positive-side sheet body includes a first metal foil layer, a positive active material layer laminated in a region as part of a first surface of the first metal foil layer, a first thermoplastic resin layer provided in a peripheral edge part where no positive active material layer is provided, on the first surface of the first metal foil layer, and a first insulation resin film layer laminated on a second surface of the first metal foil layer. The negative-side sheet body includes a second metal foil layer, a negative active material layer laminated in a region as part of a first surface of the second metal foil layer, a second thermoplastic resin layer provided in a peripheral edge part where no negative active material layer is provided, on the first surface of the second metal foil layer, and a second insulation resin film layer laminated on a second surface of the second metal foil layer. The positive active material layer is placed between the first metal foil layer and the separator. The negative active material layer is placed between the second metal foil layer and the separator. The first thermoplastic resin layer of the positive-side sheet body is fused to the second thermoplastic resin layer of the negative-side sheet body to form a peripheral edge sealing layer such that the positive-side sheet body and the negative-side sheet body are laminated in an integrated manner. An electrolytic solution is enclosed between the separator and the positive active material layer. An electrolytic solution is enclosed between the separator and the negative active material layer. A peripheral edge part of the separator enters an intermediate part, in a thickness direction, of an inner peripheral surface of the peripheral edge sealing layer in an engaged manner.

Japanese Unexamined Patent Application Publication No. 2013-114929 (JP 2013-114929 A) describes a thin battery including a power generation element, two outer packaging bodies to seal up the power generation element, a positive current collector terminal, and a negative current collector terminal. The positive current collector terminal is connected to a positive current collecting portion of the power generation element and covers at least part of at least a first surface out of the opposite outer surfaces of the power generation element in its lamination direction. The negative current collector terminal is connected to a negative current collecting portion of the power generation element and covers at least part of at least a second surface out of the opposite outer surfaces of the power generation element in the lamination direction. In the outer periphery of the power generation element, at least sides where the positive current collecting portion and the negative current collecting portion are provided, respectively, are surrounded by either or both of the two outer packaging bodies that are bent. The two outer packaging bodies are subjected to a first bonding to be bonded to the opposite outer surfaces of the power generation element in the lamination direction. In the outer periphery of the power generation element with the lamination direction being taken as an axis, sides not covered with the two outer packaging bodies thus bent are subjected to a second bonding such that the two outer packaging bodies are bonded to each other, outside the power generation element. An adhesive surface for the first bonding is wider than an adhesive surface for the second bonding.

### SUMMARY

There has been known a solid-state battery including a positive current collector layer, a positive active material layer, an electrolyte layer, a negative active material layer, and a negative current collector layer in this order. It is demanded to improve the area energy density of such a solid-state battery.

An object of this disclosure is to provide a solid-state battery having an improved area energy density.

The inventors of this disclosure found that the object could be achieved by the following means.

Aspect 1

A solid-state battery includes a first current collector layer, a first active material layer, an electrolyte layer, a second active material layer, a second current collector layer, and an insulating layer that are laminated in this order. The first current collector layer is wound on a laminated body including the first active material layer, the electrolyte layer, the second active material layer, the second current collector layer, and the insulating layer to surround the laminated body. The first current collector layer forms an outer packaging body such that overlapped parts of the first current collector layer are joined to each other at a position overlapping with a surface of the laminated body in a lamination direction of the laminated body.

Aspect 2

In the solid-state battery according to Aspect 1, the second current collector layer may project outside the outer packaging body in a direction perpendicular to a winding direction of the first current collector layer.

Aspect 3

In the solid-state battery according to Aspect 1 or 2, the first current collector layer may be made of metal.

Aspect 4

In the solid-state battery according to any one of Aspects 1 to 3, when the solid-state battery is viewed from the lamination direction of the laminated body, the second active material layer may be placed inside an outer periphery of the first active material layer. A joined portion where the overlapped parts of the first current collector layer are joined to each other may overlap with a whole surface of the second active material layer.

Aspect 5

In the solid-state battery according to any one of Aspects 1 to 4, the laminated body may have a longitudinal direction and a short direction. The first current collector layer may be wound on the laminated body around an axis along the longitudinal direction.

Aspect 6

In the solid-state battery according to any one of Aspects 1 to 5, when the solid-state battery is viewed from the lamination direction of the solid-state battery, the second current collector layer and the second active material layer may be placed inside an outer periphery of the insulating layer.

Aspect 7

A solid-state battery includes a first current collector layer, a first active material layer, an electrolyte layer, a second active material layer, and a second current collector layer that are laminated in this order. Each of the first current collector layer and the second current collector layer is wound on a laminated body including the first active material layer, the electrolyte layer, the second active material layer, and a current collector layer different from the each of the first current collector layer and the second current collector layer to sandwich the laminated body. The first current collector layer and the second current collector layer form an outer packaging body such that the each of the first current collector layer and the second current collector layer is joined to the current collector layer different from the each of the first current collector layer and the second current collector layer via a seal material having an insulating property, at a position overlapping with a surface of the laminated body in a lamination direction of the laminated body.

Aspect 8

In the solid-state battery according to Aspect 7, the first current collector layer and the second current collector layer may be made of metal.

Aspect 9

In the solid-state battery according to Aspect 7 or 8, when the solid-state battery is viewed from the lamination direction of the laminated body, the second active material layer may be placed inside an outer periphery of the first active material layer. A joined portion where the first current collector layer and the second current collector layer are joined to each other may overlap with a whole surface of the second active material layer.

Aspect 10

In the solid-state battery according to any one of Aspects 7 to 9, the laminated body may have a longitudinal direction and a short direction. The each of the first current collector layer and the second current collector layer may be wound on the laminated body around an axis along the longitudinal direction.

With this disclosure, it is possible to provide a solid-state battery having an improved area energy density.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic view of a solid-state battery 1 according to a first embodiment of this disclosure;

FIG. 2 is a sectional view along a line A-A of the solid-state battery 1 in FIG. 1 according to the first embodiment of this disclosure;

FIG. 3 is a schematic view illustrating part of an internal structure of the solid-state battery 1 according to the first embodiment of this disclosure when the solid-state battery 1 is viewed in its lamination direction;

FIG. 4 is a sectional view of a solid-state battery 2 different from the first embodiment of this disclosure;

FIG. 5 is a schematic view illustrating part of an internal structure of the solid-state battery 2 different from the first embodiment of this disclosure when the solid-state battery 2 is viewed in its lamination direction; and

FIG. 6 is a sectional view of a solid-state battery 3 according to a second embodiment of this disclosure, similar to the sectional view along the line A-A in FIG. 1.

### DETAILED DESCRIPTION OF EMBODIMENTS

The following will describe details of embodiments of this disclosure. Note that this disclosure is not limited to the following embodiments and can be carried out with various modifications within the gist of this disclosure. Note that the embodiments of this disclosure will be described below with a lithium-ion battery being taken as an example, but a solid-state battery of this disclosure is not limited to the lithium-ion battery.

### First Embodiment

A solid-state battery according to a first embodiment of this disclosure is a solid-state battery including a first current collector layer, a first active material layer, an electrolyte layer, a second active material layer, a second current collector layer, and an insulating layer that are laminated in this order. The first current collector layer is wound on a laminated body including the first active material layer, the electrolyte layer, the second active material layer, the second current collector layer, and the insulating layer to surround the laminated body. The first current collector layer forms an outer packaging body such that overlapped parts of the first current collector layer are joined to each other at a position overlapping with a surface of the laminated body in its lamination direction.

In the solid-state battery according to the first embodiment of this disclosure, the first current collector layer is wound on the laminated body including the first active material layer, the electrolyte layer, the second active material layer, the second current collector layer, and the insulating layer to surround the laminated body. The first current collector layer forms the outer packaging body such that the overlapped parts of the first current collector layer are joined to each other at the position overlapping with the surface of the laminated body in the lamination direction. That is, the solid-state battery according to the first embodiment of this disclosure has a structure where the first current collector layer is wound on the laminated body such that the first current collector layer has overlapped parts at the position overlapping with the surface of the laminated body in the lamination direction. Accordingly, the structure of the solid-state battery is a structure where the solid-state battery is sealed such that corresponding parts of the first current collector layer as an outer packaging body are joined to each other in the overlapped parts of the first current collector layer or in end parts of the first current collector layer in a direction perpendicular to the winding direction of the first current collector layer.

Hereby, in the solid-state battery according to the first embodiment of this disclosure, it is not necessary to place, on a side surface of the solid-state battery, a seal material to seal the solid-state battery in the outer packaging body. Accordingly, it is possible to increase the areas of the first active material layer, the electrolyte layer, and the second active material layer when the solid-state battery is viewed from the lamination direction, thereby making it possible to increase the areas of the first active material layer, the electrolyte layer, and the second active material layer per unit area of a product of the solid-state battery including the outer packaging body. In addition, since the first current collector layer serves as the outer packaging body, an additional outer packaging body covering the solid-state battery is not required.

Accordingly, the solid-state battery according to the first embodiment of this disclosure has a large area energy density.

Note that the area energy density is a capacity per unit area of the solid-state battery, and a larger value of the area energy density is more advantageous to downsizing of the battery.

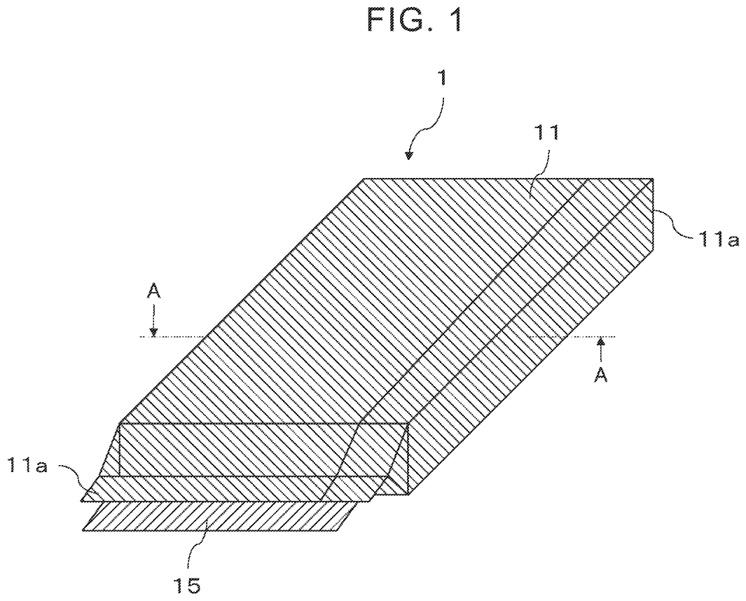

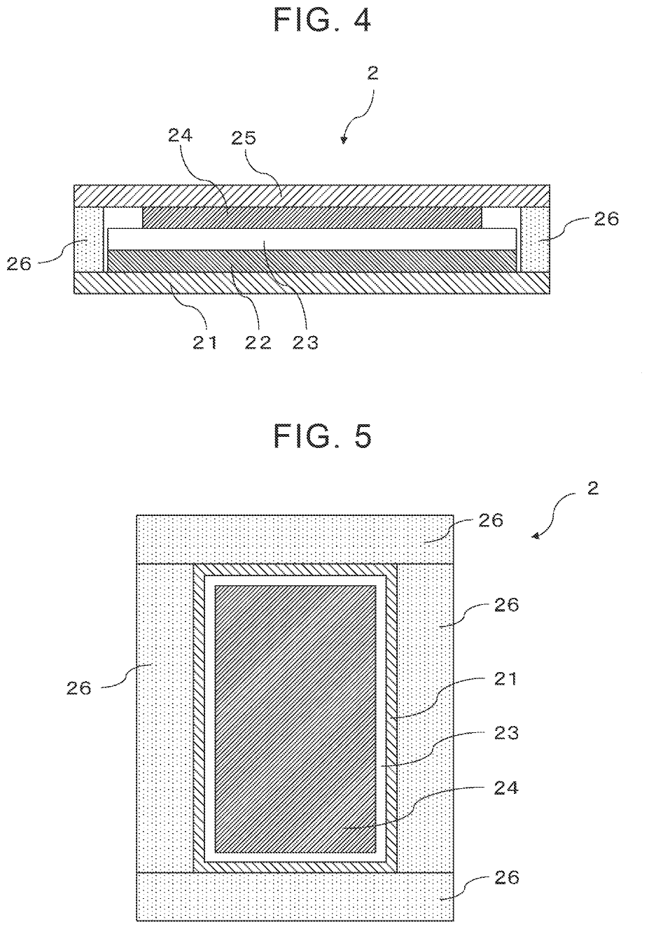

The following more specifically describes a solid-state battery 1 according to the first embodiment of this disclosure with reference to FIGS. 1 to 3 related to the solid-state battery 1 and FIGS. 4, 5 related to a solid-state battery 2 different from the first embodiment of this disclosure as examples. Note that FIGS. 1 to 3 and FIGS. 4, 5 are not intended to limit the solid-state battery of this disclosure.

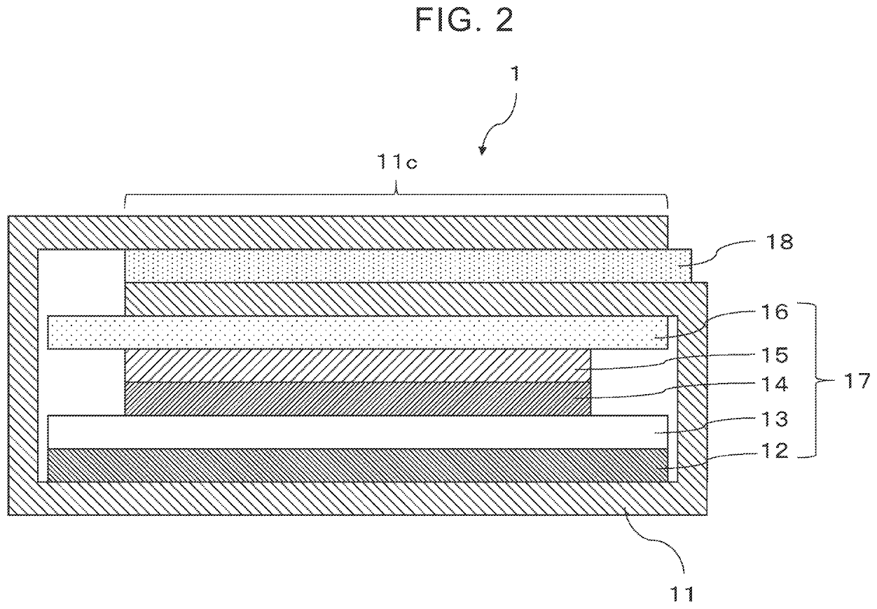

FIG. 1 is a schematic view of the solid-state battery 1 according to the first embodiment of this disclosure. Further, FIG. 2 is a sectional view along a line A-A of the solid-state battery 1 in FIG. 1 according to the first embodiment of this disclosure.

As illustrated in FIGS. 1, 2, the solid-state battery 1 according to the first embodiment of this disclosure includes a negative current collector layer 11, a negative active material layer 12, a solid electrolyte layer 13, a positive active material layer 14, a positive current collector layer 15, and an insulating layer 16 that are laminated in this order. Here, the negative current collector layer 11 is wound on a laminated body 17 including the negative active material layer 12, the solid electrolyte layer 13, the positive active material layer 14, the positive current collector layer 15, and the insulating layer 16 to surround the laminated body 17. The negative current collector layer 11 forms an outer packaging body such that overlapped parts of the negative current collector layer 11 are joined to each other via an adhesive layer 18 at a position overlapping with a surface of the laminated body 17 in its lamination direction. In either end 11a, in a direction perpendicular to the winding direction, of the negative current collector layer 11 constituting the outer packaging body, facing parts of the negative current collector layer 11, the facing parts being facing each other in the lamination direction, are bonded to each other via an adhesive layer 19. Further, the positive current collector layer 15 projects outside the outer packaging body in the direction perpendicular to the winding direction of the negative current collector layer 11. Note that, although not illustrated herein, in a part where the positive current collector layer 15 projects outwardly from the inside of the outer packaging body constituted by the negative current collector layer 11, the positive current collector layer 15 and the negative current collector layer 11 are bonded to each other via an adhesive layer having an insulating property or via an adhesive layer with an insulating member being provided between the positive current collector layer 15 and the negative current collector layer 11.

The solid-state battery 1 according to the first embodiment of this disclosure can be used, for example, such that at least part of the negative current collector layer 11 constituting the outer packaging body and at least part of the positive current collector layer 15 projecting outside the outer packaging body are connected to an external circuit. Note that the configuration where the positive current collector layer 15 projects outside the outer packaging body is not an essential configuration. For example, the positive current collector layer 15 may be joined to a positive current collector tab inside the outer packaging body, and the positive current collector tab may project outside the outer packaging body.

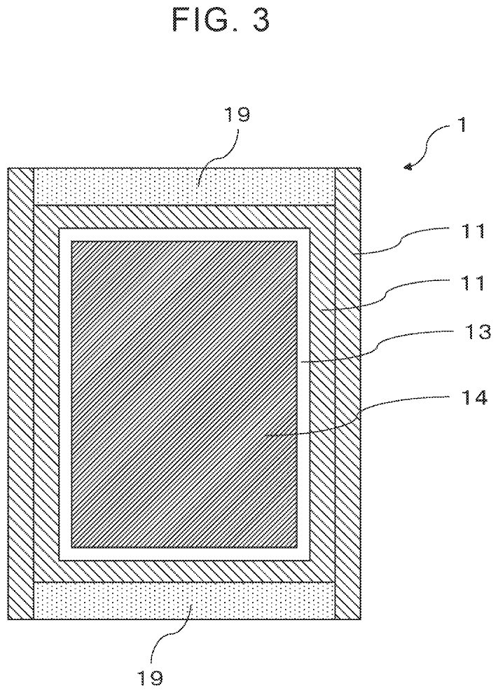

FIG. 3 is a schematic view illustrating part of an internal structure of the solid-state battery 1 according to the first embodiment of this disclosure when the solid-state battery 1 is viewed in the lamination direction. More specifically, FIG. 3 illustrates a partial structure including the negative current collector layer 11, the negative active material layer 12, the solid electrolyte layer 13, and the positive active material layer 14 from the deep side to the near side on the plane of paper.

As illustrated in FIG. 3, in the solid-state battery 1 according to the first embodiment of this disclosure, the outer packaging body constituted by the negative current collector layer 11 is sealed by the adhesive layers 18, 19, at a position (not illustrated) overlapping with a surface of the laminated body 17 in the lamination direction and in both end parts of the outer packaging body in the direction perpendicular to the winding direction of the negative current collector layer 11. In the meantime, it is not necessary that any adhesive layer be placed in both end parts of the outer packaging body in the winding direction of the negative current collector layer 11 when the outer packaging body is viewed in the lamination direction. Accordingly, in terms of the winding direction, the widths of the negative active material layer 12, the solid electrolyte layer 13, and the positive active material layer 14 can be increased. Further, since the negative current collector layer 11 serves as the outer packaging body, an additional outer packaging body covering the solid-state battery is not required.

Accordingly, the solid-state battery 1 according to the first embodiment of this disclosure has a large area energy density.

In the meantime, as illustrated in FIGS. 4, 5, the solid-state battery 2 different from the first embodiment of this disclosure has a structure where a negative current collector layer 21, a negative active material layer 22, a solid electrolyte layer 23, a positive active material layer 24, and a positive current collector layer 25 are laminated in this order, but when the solid-state battery 2 is viewed from the lamination direction, edges of the solid-state battery 2 are sealed by sealing members 26. In such a configuration, as illustrated in FIG. 5, when the solid-state battery 2 is viewed from the lamination direction, the sealing members 26 are placed to surround the negative active material layer 22, the solid electrolyte layer 23, and the positive active material layer 24. Accordingly, in comparison with the solid-state battery 1 according to the first embodiment of this disclosure, the widths of the negative active material layer 22, the solid electrolyte layer 23, and the positive active material layer 24 are small.

In the solid-state battery according to the first embodiment of this disclosure, it is preferable that the second current collector layer project outside the outer packaging body in the direction perpendicular to the winding direction of the first current collector layer. With such a configuration, it is possible to reduce the number of components such as a current collector tab.

Further, when the solid-state battery according to the first embodiment of this disclosure is viewed from the lamination direction of the laminated body, it is preferable that the second active material layer be placed inside the outer periphery of the first active material layer, and a joined portion where the overlapped parts of the first current collector layer are joined to each other overlap with the whole surface of the second active material layer. Since the second active material layer is placed inside the outer periphery of the first active material layer, the first current collector layer is hard to make contact with the positive active material layer and the positive current collector layer in a state where the first current collector layer is wound, so that internal short-circuit is restrained. Further, since the joined portion where the overlapped parts of the first current collector layer are joined to each other overlaps with the whole surface of the second active material layer, it is possible to restrain unevenness of the pressure applied to the second active material layer in the in-plane direction of the second active material layer when a plurality of solid-state batteries according to the first embodiment of this disclosure is put on top of each other in the lamination direction and bundled, or when the solid-state battery according to the first embodiment of this disclosure is pressurized in the lamination direction at the time of manufacture of the solid-state battery, for example.

Further, from the viewpoint of further restraining the internal short-circuit, it is preferable that the second current collector layer and the second active material layer be placed inside the outer periphery of the insulating layer when they are viewed from the lamination direction of the laminated body. When the second active material layer is placed inside the outer periphery of the insulating layer, the first current collector layer is hard to make contact with the second current collector layer and the second active material layer, particularly, respective side surfaces of the second current collector layer and the second active material layer, so that the internal short-circuit is further restrained.

Further, it is preferable that the laminated body have a longitudinal direction and a short direction and that the first current collector layer be wound on the laminated body around an axis along the longitudinal direction. With such a configuration, it is possible to reduce the area of the joined portion of the first current collector layer, necessary to seal the solid-state battery, particularly, the area of the joined portion in an end part of the first current collector layer in the direction perpendicular to the winding direction. Hereby, it is possible to reduce the area of the solid-state battery, and this is advantageous from the viewpoint of the area energy density.

First Current Collector Layer

The first current collector layer is wound on the laminated body including the first active material layer, the electrolyte layer, the second active material layer, the second current collector layer, and the insulating layer to surround the laminated body. The first current collector layer forms the outer packaging body such that the overlapped parts of the first current collector layer are joined to each other at the position overlapping with the surface of the laminated body in the lamination direction.

The material used for the first current collector layer is not limited in particular, and a material usable as a current collector for a battery can be employed appropriately.

For example, the material used for the first current collector layer may be stainless steel (SUS), aluminum, copper, nickel, iron, titanium, carbon, resin having conductivity, and the like, but the material is not limited to them.

In a case where the first current collector layer is a negative current collector, it is preferable that the material used for the first current collector layer be copper. Further, in a case where the first current collector layer is a positive current collector, it is preferable that the material used for the first current collector layer be aluminum.

The shape of the first current collector layer may be a given shape which allows the first current collector layer to be wound on the laminated body including the first active material layer, the electrolyte layer, the second active material layer, the second current collector layer, and the insulating layer to surround the laminated body and which allows the first current collector layer to form the outer packaging body such that the overlapped parts of the first current collector layer are joined to each other at the position overlapping with the surface of the laminated body in the lamination direction. Such a shape may be a foil shape, for example, but is not limited particularly.

From the viewpoint of forming the outer packaging body, it is preferable that the first current collector layer be made of a material through which water is hard to permeate. It is particularly preferable that the first current collector layer be made of metal.

First Active Material Layer

The first active material layer is a negative active material layer or a positive active material layer.

The first active material layer contains an electrode active material and optionally contains a solid electrolyte, a conductive assistant, and a binder.

Electrode Active Material

In a case where the first active material layer is a negative active material layer, the electrode active material is a negative active material.

The material for the negative active material is not limited particularly and may be metal lithium or may be a material that can occlude and discharge metal ion such as lithium ion. The material that can occlude and discharge metal ion such as lithium ion can be an alloy-based negative active material, a carbon material, or the like, for example, but is not limited to them.

The alloy-based negative active material is not limited particularly and may be, for example, an Si-alloy-based negative active material, an Sn-alloy-based negative active material, or the like. The Si-alloy-based negative active material may be silicon, silicon oxide, silicon carbide, silicon nitride, or solid solutions thereof. Further, the Si-alloy-based negative active material can include an element other than silicon, for example, Fe, Co, Sb, Bi, Pb, Ni, Cu, Zn, Ge, In, Sn, Ti, or the like. The Sn-alloy-based negative active material may be tin, tin oxide, tin nitride, solid solutions thereof, or the like. Further, the Sn-alloy-based negative active material can include an element other than tin, for example, Fe, Co, Sb, Bi, Pb, Ni, Cu, Zn, Ge, In, Ti, Si, or the like. Among them, the Si-alloy-based negative active material is preferable.

The carbon material is not limited particularly and may be, for example, hard carbon, soft carbon, graphite, or the like.

In a case where the first active material layer is a positive active material layer, the electrode active material is a positive active material.

The material for the positive active material is not limited in particular. For example, the positive active material may be lithium cobalt oxide (LiCoO₂), lithium nickel oxide (LiNiO₂), lithium manganese oxide (LiMn₂O₄), LiCo_{1/3}Ni_{1/3}Mn_{1/3}O₂, a different kind element substituent Li—Mn spinel of a composition expressed by Li₁₊ₓMn_{2-x-y}M_{y}O₄ (M is one or more types of metal elements selected from Al, Mg, Co, Fe, Ni, and Zn), or the like but is not limited to them.

Solid Electrolyte

The material for the solid electrolyte is not limited in particular. The solid electrolyte may be, for example, a sulfide solid electrolyte, an oxide solid electrolyte, a polymer electrolyte, or the like but is not limited to them.

Examples of the sulfide solid electrolyte include a sulfide-based amorphous solid electrolyte, a sulfide-based crystalline solid electrolyte, an argyrodite-type solid electrolyte, and so on, but the sulfide solid electrolyte is not limited to them. Specific examples of the sulfide solid electrolyte may be Li₂S—P₂S₅-based electrolytes (Li₇P₃S₁₁, Li₃PS₄, Li₈P₂S₉, and the like), Li₂S—SiS₂, LiI—Li₂S—SiS₂, LiI—Li₂S—P₂S₅, LiI—LiBr—Li₂S—P₂S₅, Li₂S—P₂S₅—GeS₂ (Li₁₃GeP₃S₁₆, Li₁₀GeP₂S₁₂, and the like), LiI—Li₂S—P₂O₅, LiI—Li₃PO₄—P₂S₅, Li₇₋ₓPS₆₋ₓClₓ, and so on, or combinations of any of them. However, the sulfide solid electrolyte is not limited to them.

Examples of the oxide solid electrolyte include Li₇La₃Zr₂O₁₂, Li₇₋ₓLa₃Zr₁₋ₓNbₓO₁₂, Li₇₋₃ₓLa₃Zr₂AlₓO₁₂, Li₃ₓLa_{2/3-x}TiO₃, Li₁₊ₓAlₓTi₂₋ₓ(PO₄)₃, Li₁₊ₓAlₓGe₂₋ₓ(PO₄)₃, Li₃PO₄, Li₃₊ₓPO₄₋ₓNₓ(LiPON), and so on, but the oxide solid electrolyte is not limited to them.

The sulfide solid electrolyte and the oxide solid electrolyte may be glass or may be crystallized glass (glass-ceramic).

The polymer electrolyte may be polyethylene oxide (PEO), polypropylene oxide (PPO), copolymers thereof, or the like, but the polymer electrolyte is not limited to them.

Conductive Assistant

The conductive assistant is not limited in particular. For example, the conductive assistant may be a carbon material such as Vapor Grown Carbon Fiber (VGCF) or carbon nano fiber, a metal material, or the like, but the conductive assistant is not limited to them.

Binder

The binder is not limited in particular. For example, the binder may be a material such as polyvinylidene difluoride (PVdF), butadiene rubber (BR), polytetrafluoro-ethylene (PTFE), or styrene butadiene rubber (SBR), or combinations thereof, but the binder is not limited to them.

Solid Electrolyte Layer

The solid electrolyte layer includes at least a solid electrolyte. Further, the solid electrolyte layer may include a binder or the like other than the solid electrolyte as needed. Note that the description about “First Active Material Layer” described above can be referred to as for the solid electrolyte and the binder.

Second Active Material Layer

The description about “First Current Collector Layer” can be referred to as for the second active material layer.

Note that the first active material layer and the second active material layer have polarities reverse to each other. That is, in a case where the first active material layer is a negative active material layer, the second active material layer is a positive active material layer. Similarly, in a case where the first active material layer is a positive active material layer, the second active material layer is a negative active material layer.

Second Current Collector Layer

The second current collector layer can be made of the material described in “First Current Collector Layer” described above.

The shape of the second current collector layer is not limited in particular and can be a foil shape a plate shape, a mesh shape, or the like, for example. Among them, the foil shape is preferable.

Note that the first current collector layer and the second current collector layer have polarities reverse to each other. That is, in a case where the first current collector layer is a negative current collector layer, the second current collector layer is a positive current collector layer. Similarly, in a case where the first current collector layer is a positive current collector layer, the second current collector layer is a negative current collector layer.

Insulating Layer

The insulating layer is a layer to electrically insulate the first current collector layer from the second current collector layer. The material for forming the insulating layer is not limited in particular, provided that the material has necessary insulation performance, and a well-known material can be used.

Such a material may be, for example, a resin material having an insulating property. More specifically, the material may be thermoplastic resin such as polyethylene terephthalate (PET), polypropylene (PP), polyvinylidene (PVDC) polyvinylidene difluoride (PVDF), polycarbonate (PC), or polyetherimide (PEI), rubber such as acrylonitrile-butadiene rubber (ABR) or butadiene rubber (BR), a non-conductive binder such as an epoxy-based or acryl-based binder, or the like. Further, such a material may be, for example, metal oxide having an insulating property. More specifically, alumina, zirconia, calcium oxide, magnesium oxide, or the like can be used. Further, as an insulating material, a combination of any of the abovementioned materials may be used.

In a case where a sulfide solid electrolyte is used as the solid electrolyte, it is particularly preferable to employ a material made of polyimide-based resin, e.g., Kapton tape or the like.

Adhesive Layer

As the adhesive layer, any material that can bond corresponding parts of the first current collector layer to each other can be employed. As such a material, thermoplastic resin such as polypropylene (PP) may be employed.

### Second Embodiment

A solid-state battery according to a second embodiment of this disclosure is a solid-state battery including a first current collector layer, a first active material layer, an electrolyte layer, a second active material layer, and a second current collector layer that are laminated in this order. Each of the first current collector layer and the second current collector layer is wound on a laminated body including the first active material layer, the electrolyte layer, the second active material layer, and a current collector layer different from the each of the first current collector layer and the second current collector layer to sandwich the laminated body. The first current collector layer and the second current collector layer form an outer packaging body such that the each of the first current collector layer and the second current collector layer is joined to the current collector layer different from the each of the first current collector layer and the second current collector layer via an adhesive layer having an insulating property, at a position overlapping with a surface of the laminated body in the lamination direction.

In the solid-state battery according to the second embodiment of this disclosure, each of the first current collector layer and the second current collector layer is wound on the laminated body including the first active material layer, the electrolyte layer, the second active material layer, and a current collector layer different from the each of the first current collector layer and the second current collector layer to sandwich the laminated body. The first current collector layer and the second current collector layer form the outer packaging body such that the each of the first current collector layer and the second current collector layer is joined to the current collector layer different from the each of the first current collector layer and the second current collector layer via the adhesive layer having an insulating property, at the position overlapping with the surface of the laminated body in the lamination direction. That is, the solid-state battery according to the second embodiment of this disclosure has a structure where each of the first current collector layer and the second current collector layer is wound on its corresponding laminated body such that the first current collector layer and the second current collector layer overlap with each other at the position overlapping with the surface of the laminated body in the lamination direction. Accordingly, the solid-state battery according to the second embodiment of this disclosure has such a structure that, in a part where the first current collector layer and the second current collector layer overlap with each other or in respective end parts of the first current collector layer and the second current collector layer in the direction perpendicular to the winding direction, the first current collector layer and the second current collector layer as the outer packaging body are joined to each other to seal the solid-state battery.

Hereby, in the solid-state battery according to the second embodiment of this disclosure, it is not necessary to place, on a side surface of the solid-state battery, a seal material to seal the solid-state battery in the outer packaging body.

Accordingly, it is possible to increase the areas of the first active material layer, the electrolyte layer, and the second active material layer when the solid-state battery is viewed from the lamination direction, thereby making it possible to increase the volumes of the first active material layer, the electrolyte layer, and the second active material layer per unit volume of a product of the solid-state battery including the outer packaging body. In addition, since the first current collector layer and the second current collector layer serve as the outer packaging body, an additional outer packaging body covering the solid-state battery is not required.

Accordingly, the solid-state battery according to the second embodiment of this disclosure has a large area energy density.

Note that the area energy density is a capacity per unit area of the solid-state battery, and a larger value of the area energy density is more advantageous to downsizing of the battery.

Further, when a plurality of solid-state batteries according to the second embodiment of this disclosure is put on top of each other in the lamination direction of the solid-state batteries, that is, in the lamination direction of the first current collector layer, the first active material layer, the electrolyte layer, the second active material layer, and the second current collector layer, it is possible to easily form a series circuit of the solid-state batteries with a small occupied volume.

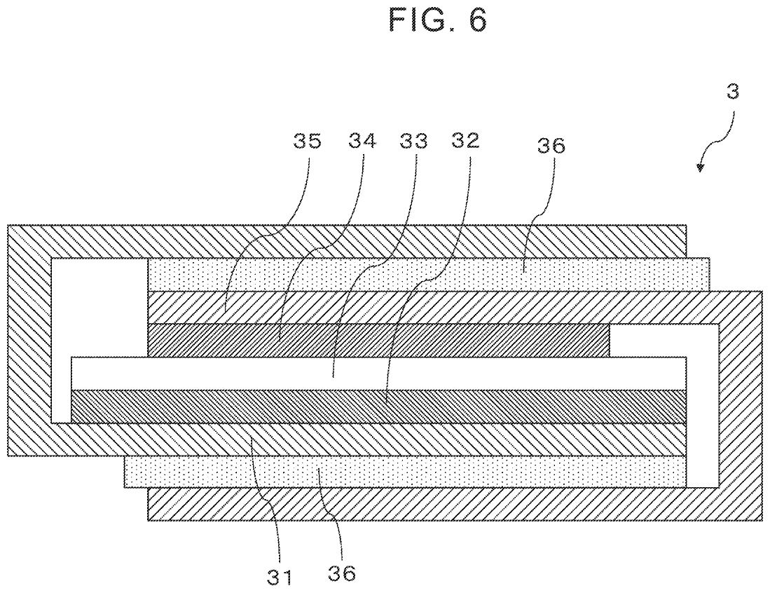

FIG. 6 is a sectional view of a solid-state battery 3 according to the second embodiment of this disclosure, similar to the sectional view along the line A-A in FIG. 1. Note that FIG. 6 is not intended to limit the solid-state battery of this disclosure.

As illustrated in FIG. 6, the solid-state battery 3 according to the second embodiment of this disclosure is a solid-state battery 3 including a negative current collector layer 31, a negative active material layer 32, a solid electrolyte layer 33, a positive active material layer 34, and a positive current collector layer 35 that are laminated in this order. Each of the negative current collector layer 31 and the positive current collector layer 35 is wound on a laminated body including the negative active material layer 32, the solid electrolyte layer 33, the positive active material layer 34, and a current collector layer different from the each of the negative current collector layer 31 and the positive current collector layer 35 to sandwich the laminated body. The negative current collector layer 31 and the positive current collector layer 35 form an outer packaging body such that the each of the negative current collector layer 31 and the positive current collector layer 35 is joined to the current collector layer different from the each of the negative current collector layer 31 and the positive current collector layer 35 via an adhesive layer 36 having an insulating property, at a position overlapping with a surface of the laminated body in the lamination direction. In either end, in a direction perpendicular to the winding direction, of the solid-state battery 3, the negative current collector layer 31 and the positive current collector layer 35 constituting the outer packaging body are bonded to each other via an adhesive layer.

The solid-state battery according to the second embodiment of this disclosure can be used, for example, such that the negative current collector layer and the positive current collector layer constituting the outer packaging body are at least partially connected to an external circuit.

Further, when the solid-state battery according to the second embodiment of this disclosure is viewed from the lamination direction of the laminated body, it is preferable that the second active material layer be placed inside the outer periphery of the first active material layer and that a joined portion where the first current collector layer is joined to the second current collector layer overlap with the whole surface of the second active material layer. Since the second active material layer is placed inside the outer periphery of the first active material layer, the first current collector layer is hard to make contact with the positive active material layer and the positive current collector layer in a state where the first current collector layer and the second current collector layer are wound, so that internal short-circuit is restrained. Further, since the joined portion where the first current collector layer is joined to the second current collector layer overlaps with the whole surface of the second active material layer, it is possible to restrain unevenness of the pressure applied to the second active material layer in the in-plane direction of the second active material layer when a plurality of solid-state batteries according to the second embodiment of this disclosure is put on top of each other in the lamination direction and bundled, or when the solid-state battery according to the second embodiment of this disclosure is pressurized in the lamination direction at the time of manufacture of the solid-state battery, for example.

Further, it is preferable that the laminated body have a longitudinal direction and a short direction and that the each of the first current collector layer and the second current collector layer be wound on the laminated body around an axis along the longitudinal direction. With such a configuration, it is possible to reduce the area of the joined portion between the first current collector layer and the second current collector layer, necessary to seal the solid-state battery, particularly, the area of the joined portion between end parts of the first current collector layer and the second current collector layer in the direction perpendicular to the winding direction. Hereby, it is possible to reduce the area of the solid-state battery, and this is advantageous from the viewpoint of the area energy density.

As for the negative current collector layer, the negative active material layer, the electrolyte layer, the positive active material layer, the positive current collector layer, the adhesive layer, and so on that can be employed in the solid-state battery according to the second embodiment of this disclosure, the description about the solid-state battery according to the first embodiment of this disclosure can be referred to.

What is claimed is:

1. A solid-state battery including a first current collector layer, a first active material layer, an electrolyte layer, a second active material layer, a second current collector layer, and an insulating layer that are laminated in this order, wherein:
the first current collector layer is wound on a laminated body including the first active material layer, the electrolyte layer, the second active material layer, the second current collector layer, and the insulating layer to surround the laminated body; and
the first current collector layer forms an outer packaging body such that overlapped parts of the first current collector layer are joined to each other at a position overlapping with a surface of the laminated body in a lamination direction of the laminated body.

2. The solid-state battery according to claim 1, wherein the second current collector layer projects outside the outer packaging body in a direction perpendicular to a winding direction of the first current collector layer.

3. The solid-state battery according to claim 1, wherein the first current collector layer is made of metal.

4. The solid-state battery according to claim 1, wherein:
when the solid-state battery is viewed from the lamination direction of the laminated body, the second active material layer is placed inside an outer periphery of the first active material layer; and
a joined portion where the overlapped parts of the first current collector layer are joined to each other overlaps with a whole surface of the second active material layer.

5. The solid-state battery according to claim 1, wherein:
the laminated body has a longitudinal direction and a short direction; and
the first current collector layer is wound on the laminated body around an axis along the longitudinal direction.

6. The solid-state battery according to claim 1, wherein, when the solid-state battery is viewed from the lamination direction of the solid-state battery, the second current collector layer and the second active material layer are placed inside an outer periphery of the insulating layer.

7. A solid-state battery including a first current collector layer, a first active material layer, an electrolyte layer, a second active material layer, and a second current collector layer that are laminated in this order, wherein:
each of the first current collector layer and the second current collector layer is wound on a laminated body including the first active material layer, the electrolyte layer, the second active material layer, and a current collector layer different from the each of the first current collector layer and the second current collector layer to sandwich the laminated body; and
the first current collector layer and the second current collector layer form an outer packaging body such that the each of the first current collector layer and the second current collector layer is joined to the current collector layer different from the each of the first current collector layer and the second current collector layer via a seal material having an insulating property, at a position overlapping with a surface of the laminated body in a lamination direction of the laminated body.

8. The solid-state battery according to claim 7, wherein the first current collector layer and the second current collector layer are made of metal.

9. The solid-state battery according to claim 7, wherein:
when the solid-state battery is viewed from the lamination direction of the laminated body, the second active material layer is placed inside an outer periphery of the first active material layer; and
a joined portion where the first current collector layer and the second current collector layer are joined to each other overlaps with a whole surface of the second active material layer.

10. The solid-state battery according to claim 7, wherein:
the laminated body has a longitudinal direction and a short direction; and
the each of the first current collector layer and the second current collector layer is wound on the laminated body around an axis along the longitudinal direction.
